(19) United States
(12) Patent Application Publication
(10) Pub. No.: US 2011/0258355 A1
(43) Pub. Date: Oct. 20, 2011

(54) MODULAR MASS STORAGE DEVICES AND METHODS OF USING

(75) Inventor: Franz Michael Schuette, Colorado Springs, CO (US)

(73) Assignee: OCZ TECHNOLOGY GROUP, INC., San Jose, CA (US)

(21) Appl. No.: 12/903,260

(22) Filed: Oct. 13, 2010

Related U.S. Application Data
(60) Provisional application No. 61/250,900, filed on Oct. 13, 2009.

(51) Int. Cl. G06F 13/00

(52) U.S. Cl. 710/301

(57) ABSTRACT

A modular mass storage device suitable for use with computers and other processing apparatuses. The mass storage device includes a controller board having a system interface connector, a memory controller, a cache device, and a second connector. The mass storage device further includes a daughter board having at least one non-volatile memory device for data storage, a read-only memory device containing firmware of the mass storage device, and a daughter board connector configured to mate with the second connector of the controller board and thereby form command, address and data paths between the memory controller and the memory device of the daughter board. The memory controller and the memory device are configured so that the memory controller reads the firmware of the read-only memory device when the daughter board connector is mated with the second connector of the controller board.

### CROSS REFERENCE TO RELATED APPLICATIONS

This application claims the benefit of U.S. Provisional Application No. 61/250,900, filed Oct. 13, 2009, the contents of which are incorporated herein by reference.

### BACKGROUND OF THE INVENTION

The present invention generally relates to memory devices for use with computers and other processing apparatuses. More particularly, this invention relates to a custom-configurable non-volatile or permanent memory-based mass storage device with a simplified design using modular components.

Mass storage devices such as advanced technology attachment (ATA) drives and small computer system interface (SCSI) drives are rapidly adopting non-volatile memory technology such as flash memory or other emerging solid-state memory technology including phase change memory (PCM), resistive random access memory (RRAM), magnetoresistive random access memory (MRAM), ferromagnetic random access memory (FRAM), organic memories, and nanotechnology-based storage media such as carbon nanofiber/nanotube-based substrates. Currently the most common technology uses NAND flash memory as inexpensive storage memory.

In most designs, a solid-state drive (SSD) uses a single printed circuit board (PCB) having a system interface connector (for example, a SATA (serial advanced technology attachment) interface connector), non-volatile memory components (for example, NAND flash memory chips), an SSD controller with control logic adapted to bridge the interface connector to the memory components, and a fast cache of DRAM or SRAM. Additionally, SSDs also typically feature a read-only memory (ROM) chip containing the operational parameters of the controller as well as information regarding the memory configuration of the entire SSD. The information stored in the ROM chip is referred to as the firmware of the SSD.

From the standpoint of inventory management, having several capacities of solid-state drives in stock is desirable, but can lead to a backlog of hot-sellers and slow-moving inventory of models that are not in as much demand was projected. Moreover, the SSD market is highly dynamic and a previous week's slow-moving items may be in high demand the following week. In this context, another problem in the SSD market is constant price erosion, meaning that inventory that is not turned over immediately often will have to be sold below cost. As such, there is an ongoing need for ways to minimize dead inventory.

### BRIEF DESCRIPTION OF THE INVENTION

The present invention provides a modular mass storage device suitable for use with computers and other processing apparatuses.

According to a first aspect of the invention, a modular non-volatile memory-based mass storage device is provided that includes a controller board having a system interface connector, a memory controller, a cache device, and a second connector. The mass storage device further includes at least a first daughter board having at least one non-volatile memory device for data storage, a read-only memory device containing firmware of the mass storage device, and a first daughter board connector configured to mate with the second connector of the controller board and thereby form command, address and data paths between the memory controller of the controller board and the non-volatile memory device of the first daughter board. The memory controller of the controller board and the read-only memory device of the first daughter board are configured so that the memory controller reads the firmware of the read-only memory device when the first daughter board connector is mated with the second connector of the controller board.

According to yet another aspect of the invention, the controller board may lack any non-volatile memory devices and therefore rely on the first daughter board for data storage, or can have one or more non-volatile memory devices and a read-only memory device containing a primary firmware of the mass storage device. In the latter case, the primary firmware of the controller board may be partially disabled and complemented by the firmware of the daughter board when the daughter board is connected to the control board, or may be completely disabled and overridden by the firmware of the daughter board when the daughter board is connected to the control board.

Other aspects of the invention include methods of using any of the mass storage devices described above.

A significant advantage of this invention is that the mass storage device offers design flexibility as a result of being custom-configurable using modular components. In addition, the mass storage has the ability to minimize dead inventory as a result of having a modular design that enables rapid adjustments in the type and number of solid-state memory devices that can be used with the controller board.

Other aspects and advantages of this invention will be better appreciated from the following detailed description.

### BRIEF DESCRIPTION OF THE DRAWINGS

FIG. 1 schematically represents a modular solid-state drive comprising a controller board and a pair of interchangeable daughter boards that have different memory capacities and are each configured to individually connect with the controller board in accordance with an embodiment of the invention.

FIG. 2 schematically represents a modular solid-state drive comprising a controller board having a memory capacity and a daughter board having an additional memory capacity and configured to connect with the controller board in accordance with another embodiment of the invention.

### DETAILED DESCRIPTION OF THE INVENTION

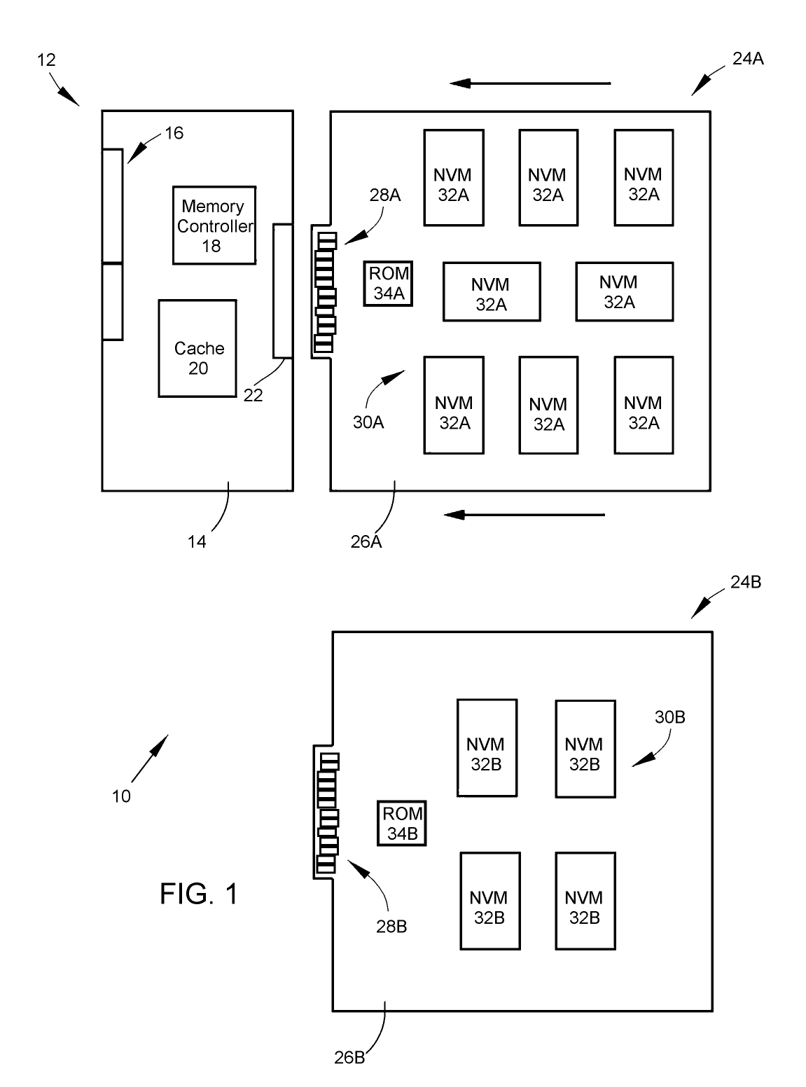

FIG. 1 depicts a non-volatile memory-based mass storage device, schematically represented as a modular solid-state drive (SSD) 10 in accordance with what is believed to be a preferred embodiment of the invention. The modular SSD 10 is shown as including a controller board 12 comprising a printed circuit board 14 having a system interface connector 16. As understood in the art, the interface connector 16 is adapted to enable the SSD 10 to be accessed by a host system (not shown), which may be a personal computer or any other suitable type of processing apparatus equipped with a data and control bus for interfacing with the SSD 10. The bus may operate with any suitable protocol known in the art, preferred but nonlimiting examples being the advanced technology attachment (ATA) bus, particularly SATA, as well as the small computer system interface (SCSI) and particularly the serially-attached SCSI (SAS). The controller board 12 further includes a memory controller 18, for example, a SATA-flash controller, and cache 20, for example, fast cache of DRAM or SRAM. Suitable components for the controller 18 and cache 20 are well known in the art and therefore will not be described in any detail here.

As represented in FIG. 1, the controller board 12 does not contain any non-volatile memory components for data storage, nor is the controller board 12 equipped with a ROM chip that contains firmware for the modular SSD 10. Instead, the controller board 12 is equipped with a board-to-board interface connector 22, which is configured for individually connecting with a daughter board of the modular SSD 10. Two such daughter boards 24A and 24B are represented in FIG. 1, though it should be understood that any number of daughter boards could be provided that are capable of connecting with the controller board 12. It should be noted here that the memory controller 18 on the controller board 12 may have, but is not required to have, embedded firmware containing a controller-specific basic input output system (BIOS).

Similar to the controller board 12, each daughter board 24A and 24B comprises a printed circuit board 26A or 26B. Furthermore, each daughter board 24A and 24B is equipped with a board-to-board interface connector 28A or 28B adapted for individually connecting the daughter board 24a or 24B to the controller board 12 through the board-to-board interface connector 22 of the controller board 12. The interfacing of the controller board 12 with the daughter board 24A and 24B through the interface connector 22 can use industry-standard connectors such as small-outline dual-inline memory module connectors (SO-DIMMs), and the interface connectors 28A and 28B of the daughter boards 24A and 24B can be in the same form factor as SO-DIMMs. Alternatively, the use of any other suitable interface connectors is foreseeable, including the use of any readily available, high-speed connectors.

According to a preferred aspect of the invention, the daughter boards 24A and 24B differ from each other, preferably as a result of having different capacities of non-volatile memory, represented as arrays 30A and 30B of non-volatile memory components 32A and 32B of any suitable type, such as NAND flash chips or any other type of solid-state memory device known or subsequently developed. It is also within the scope of the invention for the daughter boards 24A and 24B to have different types of memory devices and, in particular, different from each other. Each daughter board 24A and 24B is further provided with a ROM chip 34A or 34B, which can also be of any suitable type. The ROM chips 34A and 34B contain the operational parameters of the controller 18 on the controller board 12, as well as information regarding the memory configuration of the entire SSD 10. This information, or firmware, contains the addressing scheme for the non-volatile memory components 32A and 32B with respect to channels and levels of multi-chip packages, and preferably exactly matches the hardware configuration of the memory subsystems of each daughter board 24A and 24B, and therefore their respective non-volatile memory components 32A and 32B.

The board-to-board interface connector 22 of the controller board 12 enables the controller board 12 to be connected to the interface connector 28A or 28B of either daughter board 24A or 24B. According to a preferred aspect of the invention, when one of the daughter boards 24A or 24B is connected by its connector 28A or 28B to the controller board 12, the firmware stored on that board's ROM chip 34A or 34B automatically becomes the firmware for the entire modular SSD 10. Consequently, the connectors 22 and 28A/2B provide command, address and data paths between the memory controller 18 on the controller board 12 and the memory components 32A of the daughter board 24A or 24B connected to the controller board 12. The cache 20 on the controller board 12 is preferably adapted for buffering intermediate data and allowing command queuing for optimal utilization of the memory components 32A or 32B and their interface with the controller board 12 through the board-to-board interface connectors 22 and 28A/28B.

An alternative to the embodiment to FIG. 1 is to configure the controller board 12 to have two or more board-to-board interface connectors 22, for example, on opposite sides of the circuit board 14, enabling the controller board 12 to be simultaneously connected to each of the daughter boards 24A and 24B in FIG. 1, and possibly with other and/or additional daughter board(s) equipped with non-volatile memory components (such as the components 32A and 32B) and ROM chip (such as the chips 34A or 34B) containing firmware for the entire modular SSD 10. The firmware of the daughter boards 24A and 24B are preferably complementary so that detection of the firmware preferably causes the controller 18 on the controller board 12 to activate the necessary channels for all daughter boards 24A and 24B connected to the controller board 12. For example, each daughter board 24A and 24B may be configured to support four channels, but when both daughter boards 24A and 24B are connected to the controller board 12, the controller 18 may run in an eight-channel mode or in an interleaved dual 4-channel mode.

With either of the embodiments described above, the SSD 10 has a modular design with high flexibility that enables rapid adjustments in product line-up to meet market demands. In particular, the SSD 10 can be updated or modified by simply swapping an existing daughter board 24A/24B for another daughter board 24A/24B having different memory type and/or capacity, and/or installing an additional daughter board 24A/24B. Design flexibility is ensured by installing a daughter board 24A/24B whose non-volatile memory components 32A/32B and firmware are compatible with the memory controller 18 on the controller board 12 so that the controller 18 is capable of correctly accessing the memory array 30A/30B of the newly-installed daughter board 24A/24B.

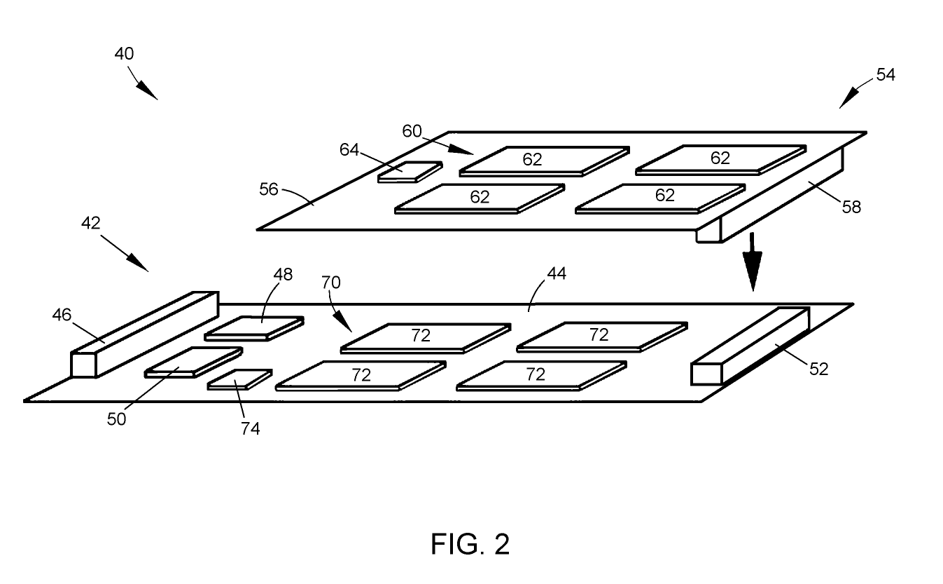

In a third embodiment shown in FIG. 2, a modular SSD 40 is provided that comprises a controller board 42 that differs from the controller board 12 of FIG. 1 as a result of its ability to be a functionally complete solid-state drive with its own array 70 of non-volatile memory components 72 and a ROM chip 74 containing “primary” firmware for the SSD 40. Similar to the modular SSD 10 of FIG. 1, the controller board 42 of the modular SSD 40 comprises a printed circuit board 44 having a system interface connector 46 (for example, a SATA connector), a memory controller 48 (for example, a SATA-flash controller), and cache 50 (for example, DRAM or SRAM). Also similar to the embodiment of FIG. 1, the modular SSD 40 includes a daughter board 54 that comprises a printed circuit board 56 equipped with a board-to-board interface connector 58 adapted for connecting the daughter board 54 to a board-to-board interface connector 52 on the controller board 42. The daughter board 54 is further represented as having an array 60 of non-volatile memory components 62, such as NAND flash chips, and a ROM chip 64 that contains “secondary” firmware for the SSD 40.

In the embodiment of FIG. 2, the memory components 72 are able to provide the controller board 42 with a memory capacity that can be upgraded or otherwise modified by connecting the daughter board 54 to the controller board 42 via their board-to-board interface connectors 52 and 58. In this case, detection of the secondary firmware contained on the ROM chip 64 of the daughter board 54 preferably causes the primary firmware contained on the ROM chip 74 of the controller board 42 to be partially or completely disabled, and the secondary firmware on the daughter board 54 then either complements or completely overrides, respectively, the primary firmware of the controller board 42. For example, the primary firmware contained by the ROM chip 74 may contain necessary data for the operation of the memory controller 48 and its interfacing with a host system (basic input output system; BIOS). This data may be stored in one area of the ROM chip 74, and a placeholder can be provided for data supplied by the firmware contained by the ROM chip 64 of the daughter board 54. In this case, the data supplied by the firmware of the daughter board 54 preferably contains detailed information regarding the array 60 of memory components 62 on the daughter board 54 and operational parameters of the memory components 62, such that the firmware of the daughter board 54 constitutes a complementary firmware that is able to work in conjunction with the primary firmware of the controller board 42. The firmware of the daughter board 54 can be used to configure the memory addressing of the memory components 62 on the daughter board 54, and possibly configure the drive interaction with the host system accessing the SSD 40 through the system interface connector 46. The cache 50 on the controller board 42 can be adapted for buffering intermediate data and allowing command queuing for optimal utilization of the memory components 62 and their interface with the controller board 42 through the board-to-board interface connectors 52 and 58.

As with the prior embodiments described in reference to FIG. 1, the SSD 40 of FIG. 2 has a modular design with high flexibility that enables rapid adjustments in product line-up to meet market demands. At the outset, the SSD 40 has the ability to be used as a functionally complete solid-state drive in view of its array 70 of non-volatile memory components 72 and ROM chip 74 containing the primary firmware for the SSD 40. Additionally, the SSD 40 can be updated or otherwise modified by simply installing a daughter board 54 whose non-volatile memory components 62 are rendered compatible with the memory controller 48 on the controller board 42 as a result of the firmware on the ROM chip 64 of the daughter board 54 partially or completely overriding the firmware on the ROM chip 74 on the controller board 42, which enables the controller 48 to correctly access the memory array 60 of the newly-installed daughter board 54. Furthermore, the modular SSD 40 can be updated or otherwise modified by simply replacing the installed daughter board 54 with another daughter board 54, whose memory components 62 may be of a different type and/or capacity.

While the invention has been described in terms of specific embodiments, it is apparent that other forms could be adopted by one skilled in the art. For example, while certain components are disclosed and preferred for the modular non-volatile memory mass storage device of this invention, it is foreseeable that functionally-equivalent components could be used or subsequently developed to perform the intended functions of the disclosed components. Therefore, the scope of the invention is to be limited only by the following claims.

1. A non-volatile memory-based mass storage device comprising:
a controller board having a system interface connector, a memory controller, a cache device, and a second connector; and
at least a first daughter board having at least one non-volatile memory device for data storage, a read-only memory device containing firmware of the mass storage device, and a first daughter board connector configured to mate with the second connector of the controller board and thereby form command, address and data paths between the memory controller of the controller board and the non-volatile memory device of the first daughter board, the memory controller of the controller board and the read-only memory device of the first daughter board being configured so that the memory controller reads the firmware of the read-only memory device when the first daughter board connector is mated with the second connector of the controller board.

2. The non-volatile memory-based mass storage device of claim 1, wherein the system interface connector is a Serial ATA or serially-attached SCSI interface connector.

3. The non-volatile memory-based mass storage device of claim 1, wherein the controller board does not comprise any non-volatile memory devices for data storage.

4. The non-volatile memory-based mass storage device of claim 3, wherein the controller board does not comprise any read-only memory device containing firmware of the mass storage device.

5. A method of using the mass storage device of claim 3, the method comprising:
connecting the first daughter board with the controller board by mating the first daughter board connector with the second connector of the controller board to form the command, address and data paths between the memory controller of the controller board and the non-volatile memory device of the first daughter board; and then
operating the memory controller of the controller board to write and read data to and from the non-volatile memory device of the first daughter board.

6. The non-volatile memory-based mass storage device of claim 3, further comprising a second daughter board having at least one non-volatile memory device for data storage, a read-only memory device containing firmware of the mass storage device, and a second daughter board connector configured to mate with the second connector of the controller board and thereby form second command, address and data paths between the memory controller of the controller board and the non-volatile memory device of the second daughter board, the memory controller of the controller board and the read-only memory device of the second daughter board being configured so that the memory controller reads the firmware of the read-only memory device of the second daughter board when the second daughter board connector is mated with the second connector of the controller board.

7. The non-volatile memory-based mass storage device of claim 6, wherein the second daughter board has a different type and/or amount of non-volatile memory devices than the first daughter board.

8. A method of using the mass storage device of claim 6, the method comprising:
connecting the first daughter board with the controller board by mating the first daughter board connector with the second connector of the controller board to form the command, address and data paths between the memory controller of the controller board and the non-volatile memory device of the first daughter board;
operating the memory controller of the controller board to write and read data to and from the non-volatile memory device of the first daughter board;
disconnecting the first daughter board from the controller board;
connecting the second daughter board with the controller board by mating the second daughter board connector with the second connector of the controller board and form the second command, address and data paths between the memory controller of the controller board and the non-volatile memory device of the second daughter board; and then
operating the memory controller of the controller board to write and read data to and from the non-volatile memory device of the second daughter board.

9. The non-volatile memory-based mass storage device of claim 6, wherein the first daughter board and the second daughter board are simultaneously connected to the controller board.

10. The non-volatile memory-based mass storage device of claim 9, wherein the firmware of the first daughter board and the second daughter board are complementary.

11. A method of using the mass storage device of claim 10, the method comprising:
detecting the firmware of the first daughter board and the firmware of the second daughter board with the memory controller; and then
allocating additional command, address and data paths to the first daughter board and the second daughter board.

12. The non-volatile memory-based mass storage device of claim 1, wherein the controller board further comprises at least one non-volatile memory device for data storage and a read-only memory device containing a primary firmware of the mass storage device, and the primary firmware of the controller board is overridden by the firmware of the first daughter board when the first daughter board is connected to the controller board.

13. The non-volatile memory-based mass storage device of claim 12, wherein the first daughter board has a different type and/or amount of non-volatile memory devices than the controller board.

14. A method of using the mass storage device of claim 12, the method comprising:
operating the memory controller of the controller board to write and read data to and from the non-volatile memory device of the controller board;
connecting the first daughter board with the controller board by mating the first daughter board connector with the second connector of the controller board to form the command, address and data paths between the memory controller of the controller board and the non-volatile memory device of the first daughter board;
overriding the primary firmware of the controller board with the firmware of the first daughter board; and then
operating the memory controller of the controller board to write and read data to and from the non-volatile memory device of the first daughter board.

15. The non-volatile memory-based mass storage device of claim 1, wherein the controller board further comprises at least one non-volatile memory device for data storage and a read-only memory device containing a primary firmware of the mass storage device, the at least one non-volatile memory device of the first daughter board is part of a memory array of non-volatile memory devices on the first daughter board, the firmware of the first daughter board has specific information about the memory array, and the primary firmware of the controller board is complemented by the firmware of the first daughter board when the first daughter board is connected to the controller board.

16. The non-volatile memory-based mass storage device of claim 15, wherein the first daughter board has a different type and/or amount of non-volatile memory devices than the controller board.

17. The non-volatile memory-based mass storage device of claim 15, wherein the primary firmware of the controller board is stored in a first region of the read-only memory device of the controller board and contains data for the operation of the memory controller and its interfacing with a host system, and a second region of the read-only memory device of the controller board provides a placeholder for data supplied by the firmware contained by the read-only memory device of the first daughter board.

18. A method of using the mass storage device of claim 15, the method comprising:
operating the memory controller of the controller board to write and read data to and from the non-volatile memory device of the controller board;
connecting the first daughter board with the controller board by mating the first daughter board connector with the second connector of the controller board to form the command, address and data paths between the memory controller of the controller board and the non-volatile memory device of the first daughter board;
partially disabling the primary firmware of the controller board with the firmware of the first daughter board and causing the firmware of the first daughter board to complement the primary firmware of the controller board; and then
operating the memory controller of the controller board to write and read data to and from the non-volatile memory device of the first daughter board.

19. The method of claim 18, wherein the primary firmware of the controller board is stored in a first region of the read-only memory device of the controller board and contains data for the operation of the memory controller and its interfacing with a host system, and a second region of the read-only memory device of the controller board provides a placeholder for data supplied by the firmware contained by the read-only memory device of the first daughter board.

20. The method of claim 19, wherein the data supplied by the firmware of the first daughter board contains information regarding the array of non-volatile memory devices on the first daughter board and operational parameters of the non-volatile memory devices thereof.
